(19) United States
(12) Patent Application Publication
(10) Pub. No.: US 2025/0010397 A1
(43) Pub. Date: Jan. 9, 2025

(54) LASER PROCESSING SYSTEM AND CONTROL DEVICE

(71) Applicant: FANUC CORPORATION, Yamanashi (JP)

(72) Inventors: Masanobu HATADA, Yamanashi (JP); Takahiro TANAKA, Yamanashi (JP)

(73) Assignee: FANUC CORPORATION, Yamanashi (JP)

(21) Appl. No.: 18/711,705

(22) PCT Filed: Dec. 22, 2021
(86) PCT No.: PCT/JP2021/047463

§ 371 Date: May 20, 2024

(51) Int. Cl. B23K 26/06; B23K 26/08

(52) U.S. Cl. CPC B23K 26/0608; B23K 26/0626; B23K 26/0884

(57) ABSTRACT

A laser processing system including a robot, a laser-light-emitting tool mounted on the robot, and a control device that controls the robot and the laser-light-emitting tool on the basis of an operation program, the laser-light-emitting tool being capable of emitting two or more different types of laser light independently from each other, and the control device being capable of issuing a plurality of laser emission instructions for causing the laser-light-emitting tool to simultaneously emit different types of laser light by using one laser processing command within the operation program.

### TECHNICAL FIELD

The present disclosure relates to laser processing systems and control devices.

### BACKGROUND

A known laser processing system in the related art includes a robot, a laser-light-emitting tool equipped at the distal end of the robot, a laser oscillator, and a control device (e.g., see Japanese Unexamined Patent Application, Publication No. 2018-086665).

In order to perform processing, such as cutting or welding, on a workpiece by using a laser beam emitted from the laser-light-emitting tool while operating the robot, for example, the output of the laser beam is changed in correspondence with the movement of the robot for every processing location.

### SUMMARY

An aspect of the present disclosure is directed to a laser processing system including a robot, a laser-light-emitting tool attached to the robot, and a control device that controls the robot and the laser-light-emitting tool based on an operation program. The laser-light-emitting tool is capable of emitting two or more different types of laser beams independently of each other. The control device is capable of executing a plurality of laser emission instructions for causing the laser-light-emitting tool to simultaneously emit the different types of laser beams in accordance with one laser processing command in the operation program.

### BRIEF DESCRIPTION OF DRAWINGS

FIG. 1 is an overall configuration diagram illustrating a laser processing system according to an embodiment of the present disclosure.

FIG. 2 illustrates an example of the operation of the laser processing system in FIG. 1.

FIG. 3 illustrates a teaching example of an operation program by a control device of the laser processing system in FIG. 1.

FIG. 4 illustrates a display example of a list of commands added as auxiliary commands to the operation program in FIG. 3.

FIG. 5 illustrates an example of a number-of-rampings setting screen displayed when a laser-processing start command is selected in FIG. 4.

FIG. 6 illustrates the details of the laser-processing start command displayed when the number of rampings is set in FIG. 5.

FIG. 7 illustrates an operation program example where laser-beam intensities and emission time periods are set for the laser-processing start command displayed in FIG. 6.

FIG. 8 illustrates a reference example of the operation program.

FIG. 9 illustrates another display example of the operation program displayed when the laser-processing start command is selected in FIG. 4.

FIG. 10 illustrates a display example of the operation program displayed when the number of rampings is edited in FIG. 9.

FIG. 11 illustrates a case where the laser-processing start command in the operation program in FIG. 7 is selected from a plurality of tables stored in advance.

FIG. 12 illustrates another example of one of the tables in FIG. 11.

FIG. 13 illustrates the table after the number of rampings has been edited in the table in FIG. 12.

FIG. 14 illustrates another example of the table in FIG. 11.

FIG. 15 illustrates the table after only required sections are set in the table in FIG. 12.

FIG. 16 is an overall configuration diagram illustrating another example of the laser processing system in FIG. 1.

FIG. 17 illustrates another example of the operation program in FIG. 7.

FIG. 18 illustrates an example of the operation of the laser processing system in FIG. 1 in accordance with the operation program in FIG. 17.

### DETAILED DESCRIPTION OF EMBODIMENTS

A laser processing system 1 and a control device 4 according to an embodiment of the present disclosure will be described below with reference to the drawings.

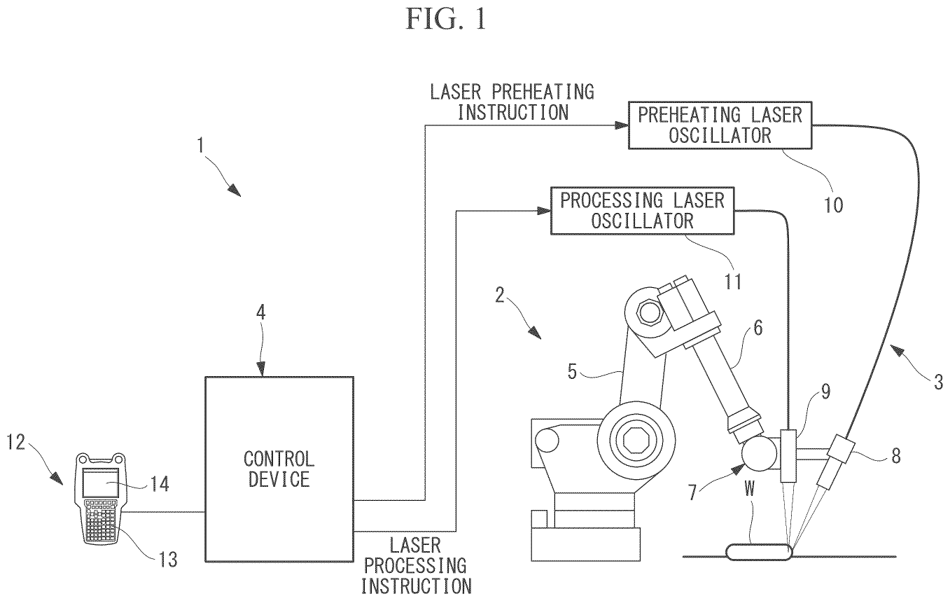

As shown in FIG. 1, the laser processing system 1 according to this embodiment includes a robot 2, a laser-light-emitting tool 3 attached to the robot 2, and the control device 4 that controls the robot 2 and the laser-light-emitting tool 3.

In the example shown in FIG. 1, the robot 2 is a vertical six-axis articulated robot, but may alternatively be of any type so long as the position and the orientation of the laser-light-emitting tool 3 can be arbitrarily moved within a three-dimensional space.

The laser-light-emitting tool 3 includes tool bodies 8 and 9 fixed to the distal end of a wrist 7 of the robot 2, and also includes laser oscillators 10 and 11 that are connected to the tool bodies 8 and 9 and that supply laser beams (different types of laser beams) to the tool bodies 8 and 9.

In the example shown in FIG. 1, the laser-light-emitting tool 3 includes two types of tool bodies 8 and 9 and two types of laser oscillators 10 and 11 respectively connected to the tool bodies 8 and 9. The laser oscillators 10 and 11 may be attached to, for example, robot arms 5 and 6 or may be fixed outside the robot 2.

In this embodiment, the two types of tool bodies 8 and 9 are a preheating tool body 8 and a processing tool body 9. The laser oscillator 10, which is for preheating, is connected to the preheating tool body 8, and the laser oscillator 11, which is for processing, is connected to the processing tool body 9. In order to simplify the drawing in FIG. 1, the two shown tool bodies 8 and 9 radiate laser beams onto the same processing location on a workpiece W along optical axes that are inclined relative to each other. Alternatively, the two types of laser beams may be radiated coaxially.

The control device 4 according to the embodiment of the present disclosure includes at least one processor (not shown) and at least one storage device (not shown), and causes the processor to process an operation program stored in the storage device, thereby controlling the robot 2 and the laser-light-emitting tool 3.

The control device 4 includes a teaching control panel 12 that is held and operated by an operator to teach the operation program. The teaching control panel 12 includes a keypad 13 for receiving an operation from the operator and a monitor 14 for displaying, for example, the taught operation program.

The operation program in the laser processing system 1 includes a plurality of program lines listed in an execution sequence. Each program line has a description of a robot operation instruction as a command for moving the robot 2. A robot operation instruction on a lower program line is executed upon completion of a robot operation instruction on an upper program line.

In this embodiment, a laser processing command, as a command for moving the laser-light-emitting tool 3, serves as an accessory command of the robot operation instruction and is described in a program line having a description of any robot operation instruction.

The laser processing command, as an accessory command, is executed with reference to the time of completion of the robot operation instruction to which the accessory command is attached.

The laser processing command includes a plurality of laser emission instructions. In this embodiment, each laser emission instruction includes a laser preheating instruction (preheating emission instruction) and a laser processing instruction (processing emission instruction). For each laser emission instruction, the laser-beam intensity and the laser-beam emission time period can be set as laser-beam emission conditions.

Specifically, the control device 4 according to this embodiment executes a plurality of laser emission instructions with different emission conditions for the laser-light-emitting tool 3 in accordance with one laser processing command during the operation program. Accordingly, a plurality of laser beams can be radiated simultaneously onto a single processing location on the workpiece W.

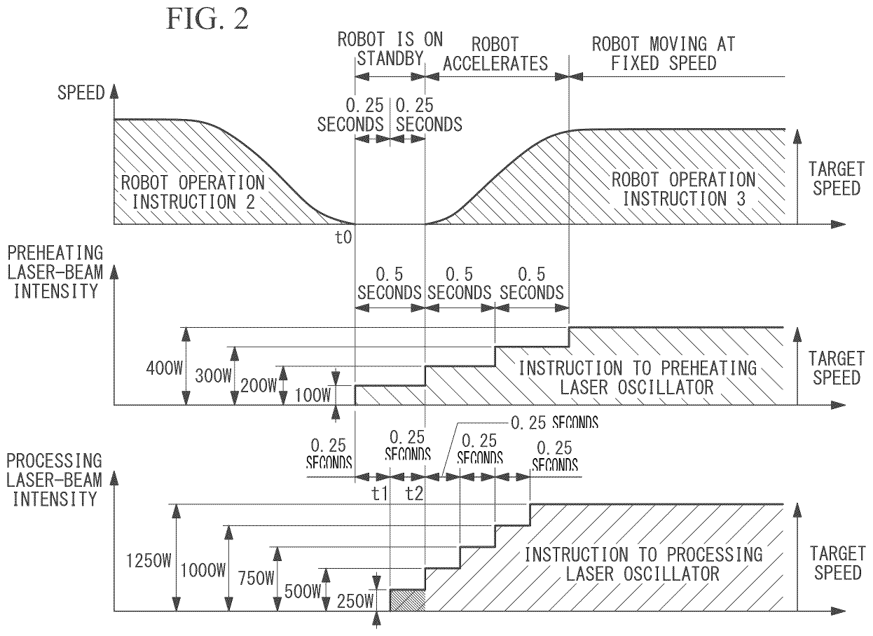

As shown in FIG. 2, at each processing location, the robot 2 is moved, the preheating laser beam is emitted, and the processing laser beam is emitted. The example shown in FIG. 2 illustrates a case where laser processing is performed in accordance with a robot operation instruction 3 upon completion of a robot operation instruction 2.

The emission of the preheating laser beam commences from a completion time point t0 of the robot operation instruction 2. The processing laser beam is emitted after a predetermined time period t1 has elapsed from the start of the emission of the preheating laser beam. Furthermore, the robot operation instruction 3 is executed after a predetermined time period t2 has elapsed from the start of the emission of the processing laser beam.

Subsequently, while the robot 2 is accelerating, the preheating laser beam from the preheating tool body 8 and the processing laser beam from the processing tool body 9 are ramped in multiple stages by, for example, increasing the intensity of the laser beams in a stepwise fashion. Then, after the robot 2 reaches a target speed, the preheating laser beam and the processing laser beam having target intensities are emitted.

Accordingly, when the robot 2 is moving at a low speed before reaching the target speed, the intensities of the preheating laser beam and the processing laser beam are regulated, thereby preventing the workpiece W from receiving excessive thermal energy. As a result, for example, an increase in bead width near the laser-processing start position can be prevented. Furthermore, each processing location is irradiated with the preheating laser beam simultaneously with the processing laser beam, so that sputtering can be reduced, thereby achieving improved processing quality and a higher processing rate.

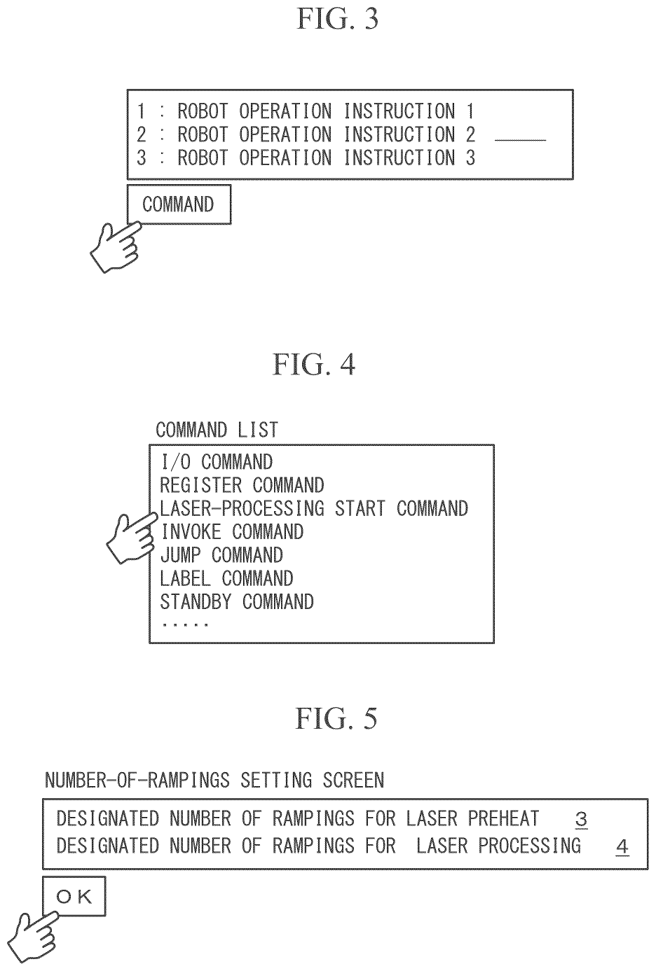

In this embodiment, as shown in FIG. 3, the control device 4 first teaches a robot operation instruction 1 to the robot operation instruction 3 to the operation program taught by the operator, and causes the monitor 14 to display the taught robot operation instructions and a command button. For example, when the operator desires to perform laser processing based on the robot operation instruction 3, the operator sets a cursor to the tail end of the program line of the robot operation instruction 2 displayed on the monitor 14, as shown in FIG. 3.

Then, the operator presses the command button displayed on the monitor 14, whereby the control device 4 causes the monitor 14 to display a command list to be added, as shown in FIG. 4, and allows the operator to select any of the commands. When the operator selects a laser-processing start command from the commands in the command list, the control device 4 allows an input of the number of times the preheating laser beam is to be ramped and the number of times the processing laser beam is to be ramped, as shown in FIG. 5.

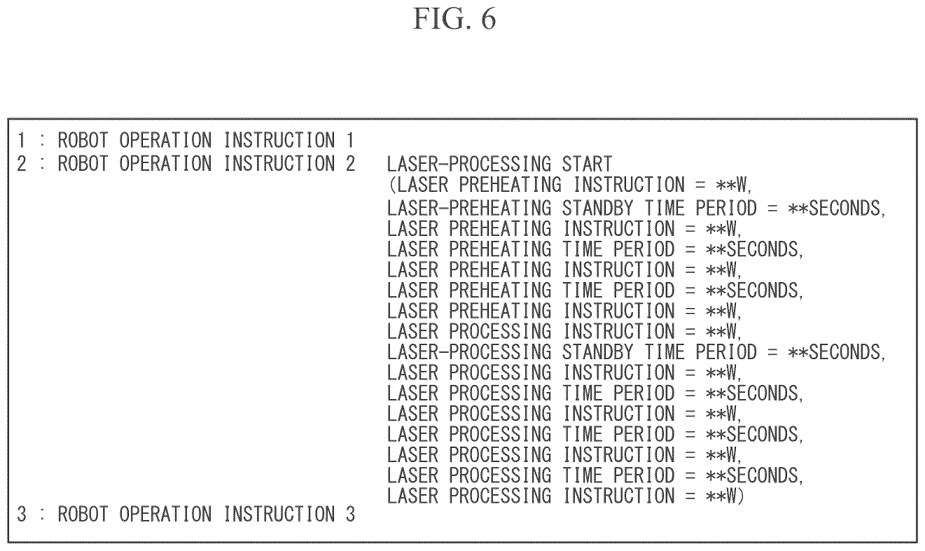

When the operator inputs each number of rampings and presses an OK button, the control device 4 displays a laser-processing start command (laser processing command) having multiple laser emission instructions listed in the execution sequence on a single program line at the tail end of the robot operation instruction 2, as shown in FIG. 6. Each laser emission instruction is displayed such that the laser-beam emission conditions are settable. The displayed laser-processing start command is displayed across multiple lines but is included within the same program line “2:” as the robot operation instruction 2.

In this embodiment, each laser emission instruction includes a laser preheating instruction (preheating emission instruction) for emitting the preheating laser beam from the preheating tool body 8 and a laser processing instruction (processing emission instruction) for emitting the processing laser beam from the processing tool body 9.

The laser-beam intensity, as one of the emission conditions for each laser beam, is settable as a parameter attached to the laser preheating instruction or the laser processing instruction, and is displayed as, for example, “**” on the monitor 14, as shown in FIG. 6.

The emission time period, as another one of the emission conditions, is settable as a parameter attached to a laser-preheating standby time period, a laser preheating time period, a laser-processing standby time period, and a laser processing time period. For example, as shown in FIG. 6, the emission time period is displayed as “**” on the monitor 14.

The laser-preheating standby time period and the laser preheating time period are attached to the laser preheating instruction so as to define the emission time period of the preheating laser beam to be emitted based on the laser preheating instruction to which the aforementioned time periods are attached. The laser-processing standby time period and the laser processing time period are attached to the laser processing instruction so as to define the emission time period of the processing laser beam to be emitted based on the laser processing instruction to which the aforementioned time periods are attached.

Furthermore, the laser-preheating standby time period not only defines the emission time period of the preheating laser beam based on the laser preheating instruction to which the laser-preheating standby time period is attached, but also sets the robot operation instruction on standby for an emission time period set as the laser-preheating standby time period. Likewise, the laser-processing standby time period not only defines the emission time period of the processing laser beam based on the laser processing instruction to which the laser-processing standby time period is attached, but also sets the robot operation instruction on standby for an emission time period set as the laser-processing standby time period.

If the laser-preheating standby time period and the laser-processing standby time period both exist, the robot operation instruction is set on standby for the longer one of the standby time periods.

On the other hand, the laser preheating time period and the laser processing time period only define the emission time periods based on the laser preheating instruction and the laser processing instruction to which the aforementioned time periods are attached, and allow the different types of instructions to be executed without waiting for the end of the emission time periods.

For example, as shown in FIG. 5, the input number of times the preheating laser beam is to be ramped is three, and the input number of times the processing laser beam is to be ramped is four. In this case, laser emission instructions, laser-preheating standby time periods, laser preheating time periods, laser-processing standby time periods, and laser processing time periods are displayed, as shown in FIG. 6. The display includes a list of four laser preheating instructions and preheating time periods and five laser processing instructions and processing time periods added within the same program line as the robot operation instruction 2.

A laser-preheating standby time period is attached to the first laser preheating instruction, a laser preheating time period is attached to each of the subsequent two laser preheating instructions, and nothing is attached to the last laser preheating instruction. A laser-processing standby time period is attached to the first laser processing instruction, a laser processing time period is attached to each of the subsequent three laser processing instructions, and nothing is attached to the last laser processing instruction.

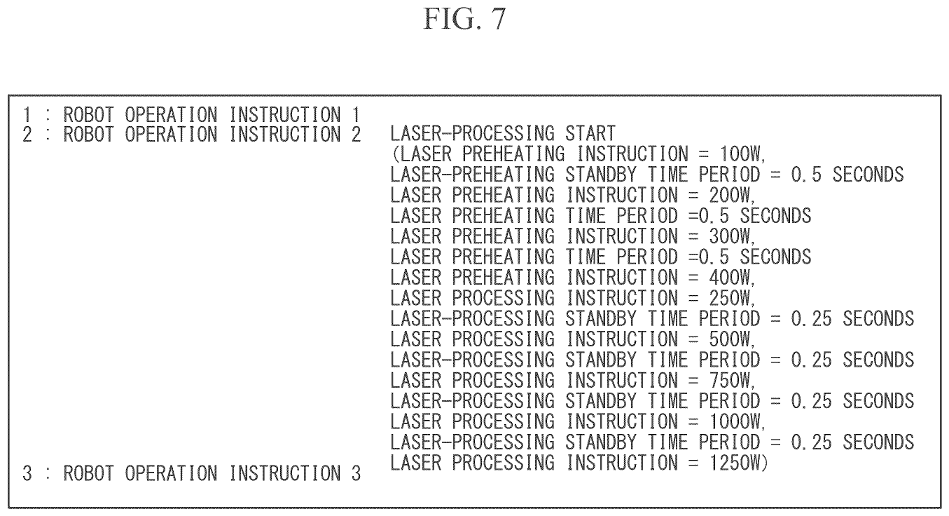

In this state, the control device 4 allows the laser-beam intensity and the emission time period, as parameters attached to each laser preheating instruction and each laser processing instruction, to be input to the respective “**” locations displayed on the monitor 14. As shown in FIG. 7, in this embodiment, for example, it is assumed that the operator inputs 100 W, 200 W, 300 W, and 400 W for the four laser preheating instructions in that order from the top. It is also assumed that the operator inputs 250 W, 500 W, 750 W, 1000 W, and 1250 W for the five laser processing instructions in that order from the top.

Furthermore, it is assumed that the operator inputs 0.5 seconds as the laser-preheating standby time period, 0.25 seconds as the laser-processing standby time period, 0.5 seconds as the laser preheating time period, and 0.25 seconds as the laser processing time period.

The operation program of the robot 2 taught in this manner is executed, whereby the robot 2, the preheating tool body 8, and the processing tool body 9 move in the following manner.

First, when the operation program is executed, the robot operation instruction 1 on the first program line “1:” is executed. Immediately upon completion of the robot operation instruction 1, the robot operation instruction 2 on the lower program line “2:” is executed.

Due to being an accessory command of the robot operation instruction 2, the laser-processing start command is not executed until the robot operation instruction 2 is completed. When the operation of the robot based on the robot operation instruction 2 is completed, the first laser preheating instruction and the first laser processing instruction of the laser-processing start command are executed with reference to the time point t0.

The first laser preheating instruction causes the preheating tool body 8 to emit a preheating laser beam with a laser-beam intensity of 100 W for an emission time period of 0.5 seconds set as the laser-preheating standby time period. The first laser processing instruction causes the processing tool body 9 to emit a processing laser beam with a laser-beam intensity of 250 W for an emission time period of 0.25 seconds set as the laser-processing standby time period.

In this case, the robot operation instruction 3 is set on standby for 0.5 seconds from the time point t0 in accordance with the laser-preheating standby time period, which is the longer time period. The laser processing instruction is set on standby for 0.25 seconds, which is a difference between 0.5 seconds as the longer laser-preheating standby time period and 0.25 seconds as the shorter laser-processing standby time period, from the time point t0.

With regard to instructions of the same type, in principle, a laser emission instruction is executed upon completion of an upper instruction in accordance with the arrangement order within the program line. In contrast, with regard to instructions of different types, a laser emission instruction is executed without waiting for the completion of the upper instruction.

As a result, as shown in FIG. 2, emission of a 100-W preheating laser beam first commences from the time point t0 when the robot operation instruction 2 has been completed, emission of a 250-W processing laser beam commences 0.25 seconds thereafter, and then the robot operation instruction 3 is executed 0.25 seconds thereafter.

When the robot operation instruction 3 is executed, the robot 2 accelerates until reaching the target speed. Upon reaching the target speed, the robot 2 moves, for example, a tool tip point at that speed.

When the robot operation instruction 3 is executed, 0.5 seconds elapse from the time point t0, so that a second 200-W laser preheating instruction and a second 500-W laser processing instruction are executed.

Subsequently, preheating laser beams with light-beam intensities changed to 300 W and 400 W every 0.5 seconds are emitted, and processing laser beams with light-beam intensities changed to 750 W, 1000 W, and 1250 W every 0.25 seconds are emitted. Accordingly, after about 1 second from the start of the robot operation instruction 3, the robot 2 reaches the target speed, and the preheating laser beam and the processing laser beam reach the target intensities. After reaching the target intensities, the preheating laser beam and the processing laser beam are stopped from being emitted or are ramped based on a laser-processing end command.

Accordingly, in the laser processing system 1 and the control device 4 according to this embodiment, multiple laser emission instructions, to be executed at a single processing location, for different types of laser beams can be collectively described in accordance with a single laser-processing start command within the operation program.

Firstly, with the selection of the laser-processing start command and the designation of the number of rampings for each laser emission instruction, the required number of laser preheating instructions and the required number of laser processing instructions can be displayed on the monitor 14 in such a manner that the emission conditions are settable. Therefore, as compared with the method in the related art where each laser emission instruction and the emission conditions are indicated on separate program lines, it is possible to prevent the operator from forgetting to teach the operation program or from making a mistake in the execution sequence even if the operator is not experienced in teaching the operation program.

Secondly, multiple laser emission instructions that are to be executed at one opening location and that have different emission conditions can be included in a single program line. Accordingly, it is possible to prevent another command included in the operation program from being mixed between multiple laser emission instructions to be executed at one processing location, thereby preventing the operation program from being complicated. As a result, it is possible to readily confirm whether the operation program for irradiating each processing location with laser beams is correct or incorrect.

For example, when an I/O command for supplying or stopping welding gas is disposed between laser emission instructions in addition to a robot operation instruction, it is difficult to confirm afterwards which laser emission instruction is to be executed at which processing location. In this embodiment, multiple laser preheating instructions and multiple laser processing instructions to be executed at a single processing location, as well as multiple emission conditions, can be included in a single line, so that it is possible to readily confirm which instruction is to be executed at which processing location.

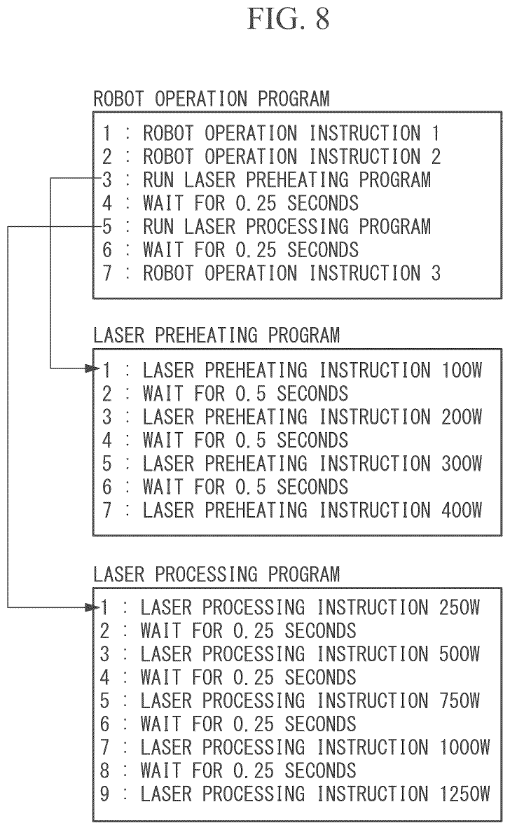

Furthermore, as shown in FIG. 8, it is conceivable that a laser preheating program and a laser processing program are executed as different tasks from a robot operation instruction. In this case, the laser preheating program and the laser processing program are separated into different programs. This makes the teaching process complicated and is problematic in that the programs cannot be confirmed at one time. Moreover, when a standby time period set during the operation program is to be adjusted, a standby time period in one of the laser preheating program and the laser processing program, which are different programs, also need to be adjusted accordingly.

In contrast, in the embodiment of the present disclosure, a preheat instruction, a processing instruction, and laser-beam emission conditions can all be described on the same program line as a robot operation instruction. This is advantageous in that the teaching process can be simplified dramatically.

The laser-beam intensity, the laser-beam emission time period, the standby time period, and the number of rampings in this embodiment are examples and may each be set to an arbitrary value. Moreover, as an alternative to the above example where the two different types of laser beams for preheating and processing are radiated, three or more different types of laser beams may be radiated.

As an alternative to this embodiment where the laser-processing start command alone is described as an example to simplify the description, the operation program may additionally include a laser-processing end instruction. Accordingly, the last laser preheating instruction and the last laser processing instruction in the laser-processing start instruction are turned off or ramped based on the laser-processing end instruction.

For example, when laser processing is to be performed until the robot 2 decelerates and stops, the preheating laser beam and the processing laser beam are ramped in correspondence with the deceleration of the robot 2 by, for example, decreasing the laser-beam intensities in a stepwise fashion. Even in this case, multiple laser preheating instructions and laser processing instructions can be listed and described on the same program line as the robot operation instruction.

Accordingly, when the robot 2 is moving at a low speed before stopping, the intensities of the preheating laser beam and the processing laser beam are regulated, thereby preventing the workpiece W from receiving excessive thermal energy. As a result, for example, an increase in bead width near the laser-processing end position can be prevented.

A laser-emission-condition changing instruction for changing the emission conditions for the preheating laser beam and the processing laser beam during laser processing may be included in the operation program. In this case, the preheating laser beam and the processing laser beam may be ramped in correspondence with the movement of the robot 2 by, for example, increasing or decreasing the laser-beam intensities in a stepwise fashion. Even in this case, multiple laser preheating instructions and laser processing instructions can be listed and described on the same program line as the robot operation instruction.

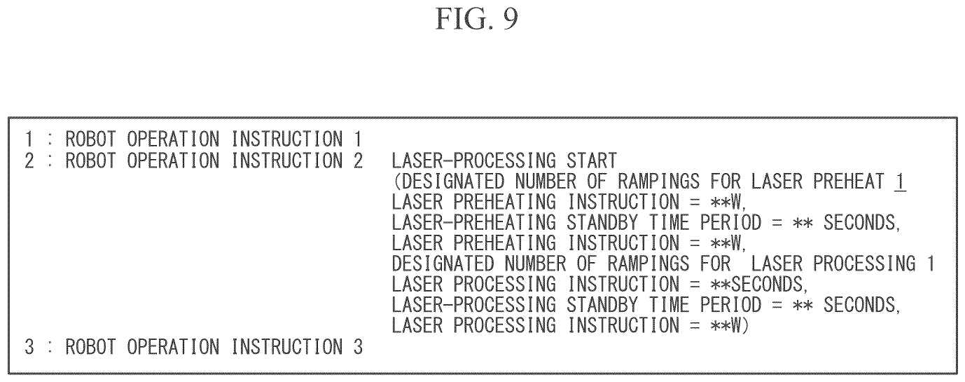

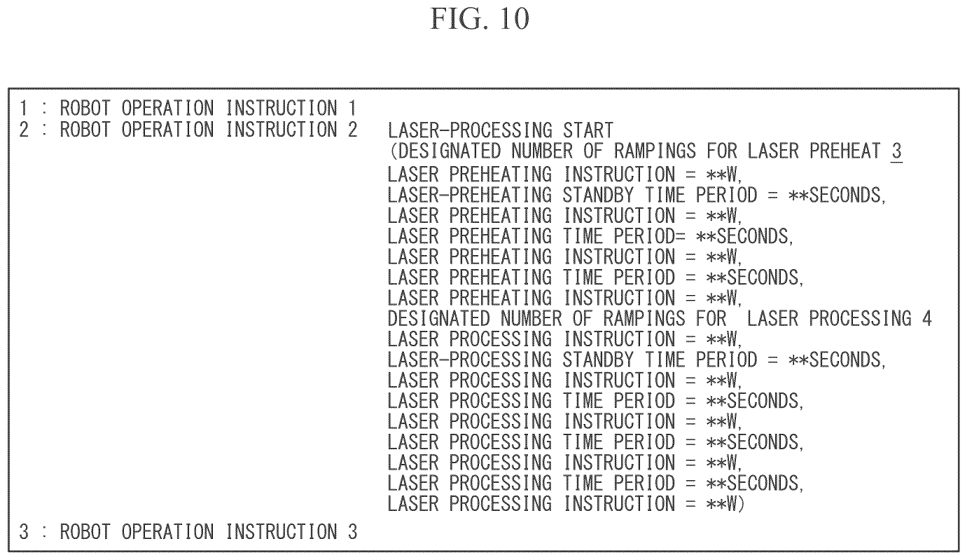

In this embodiment, as shown in FIG. 6, multiple laser emission instructions included in the laser-processing start command are listed in response to an input of the number of rampings displayed as a result of selecting the laser-processing start command. Alternatively, as shown in FIG. 9, when the laser-processing start command is selected, a laser-processing start command in which the number of rampings is set to a standard value (e.g., 1) may be displayed, and the number of rampings included in the laser-processing start command may be editable. Accordingly, as shown in FIG. 10, the laser-processing start command may be displayed with a list of laser emission instructions the number of which corresponds to the edited number of rampings.

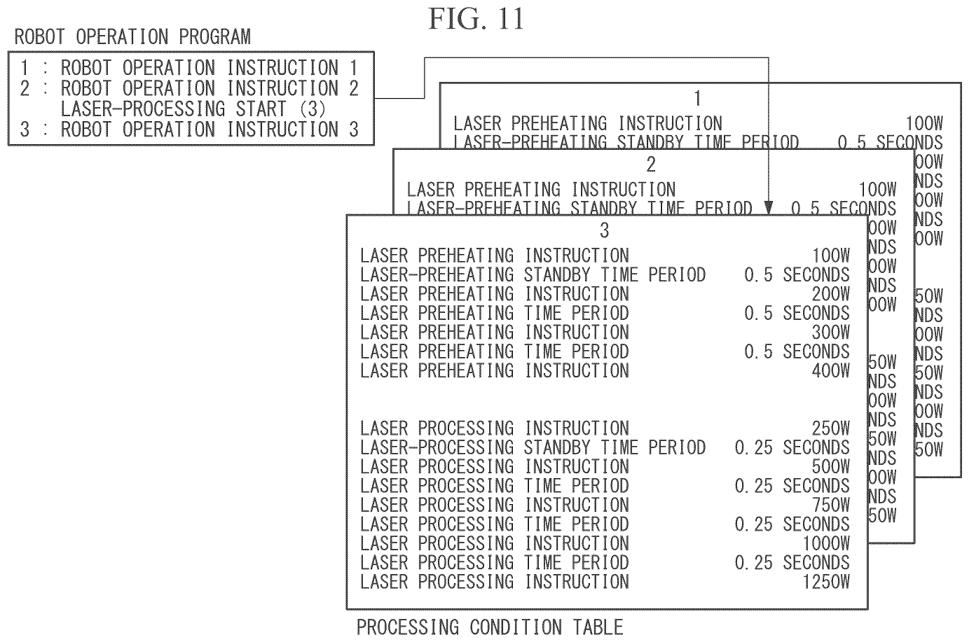

In this embodiment, for example, multiple laser emission instructions included in a laser processing command are listed on the same program line describing a robot operation instruction. Alternatively, as shown in FIG. 11, a plurality of tables in which multiple laser emission instructions for emitting different types of laser beams are listed in the execution sequence may be stored in a storage unit, and a laser processing command for invoking and executing one of the tables may be described as an accessory command of the robot operation instruction.

In the example shown in FIG. 11, a laser-processing start command for reading and executing a table designated by a number is indicated as a laser processing command. Multiple tables defining emission conditions that vary depending on, for example, the processing location may be stored with identifiers, such as numbers. Any of the tables may be selected in the selection process for the laser processing command. The selected table may be displayed on the monitor 14.

In response to an input of the number of rampings, a table may be displayed with a list of laser emission instructions the number of which corresponds to the input number of rampings. In this case, a single table in which, for example, the number of rampings, the laser-beam intensity, and the emission time period are editable may be stored, and may be edited by the operator.

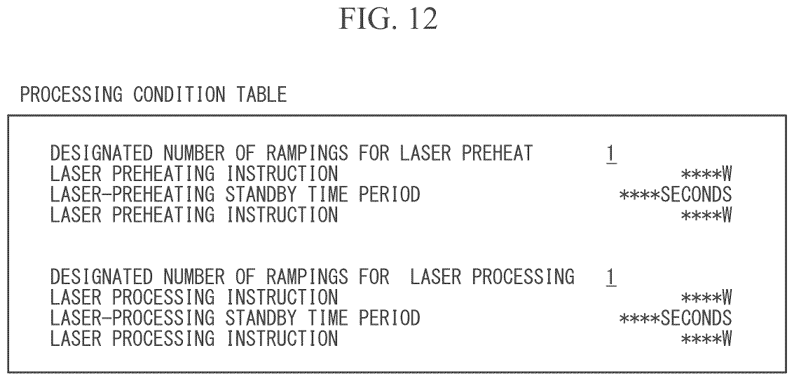

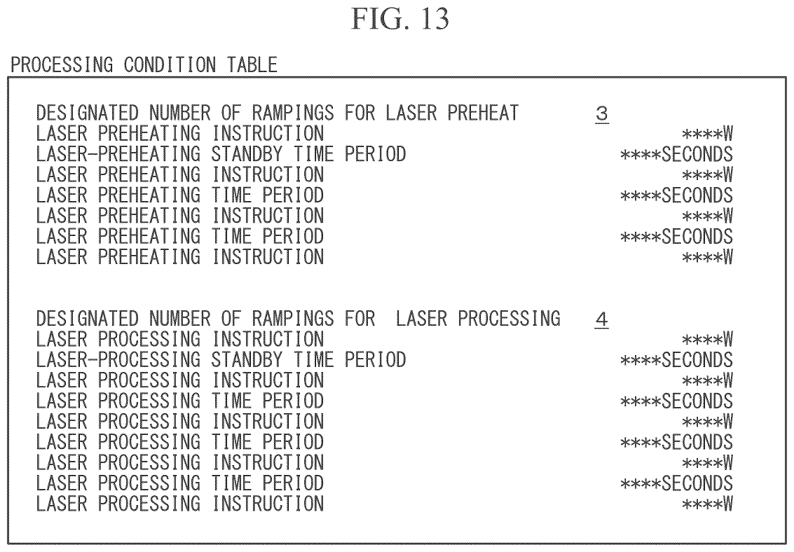

For example, in an example shown in FIG. 12, a table having “1” defined as the standard number of rampings is stored. In this case, there are two laser preheating instructions and two laser processing instructions. When the operator changes the number of rampings to “3” and “4”, the number of laser preheating instructions and the number of laser processing instructions in the table are updated to four and five, respectively, as shown in FIG. 13.

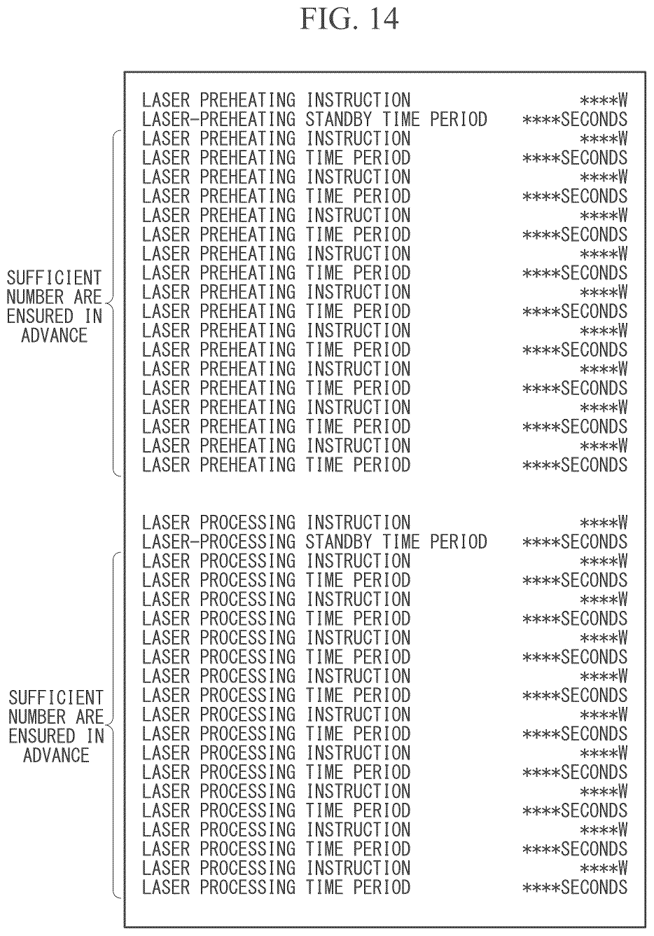

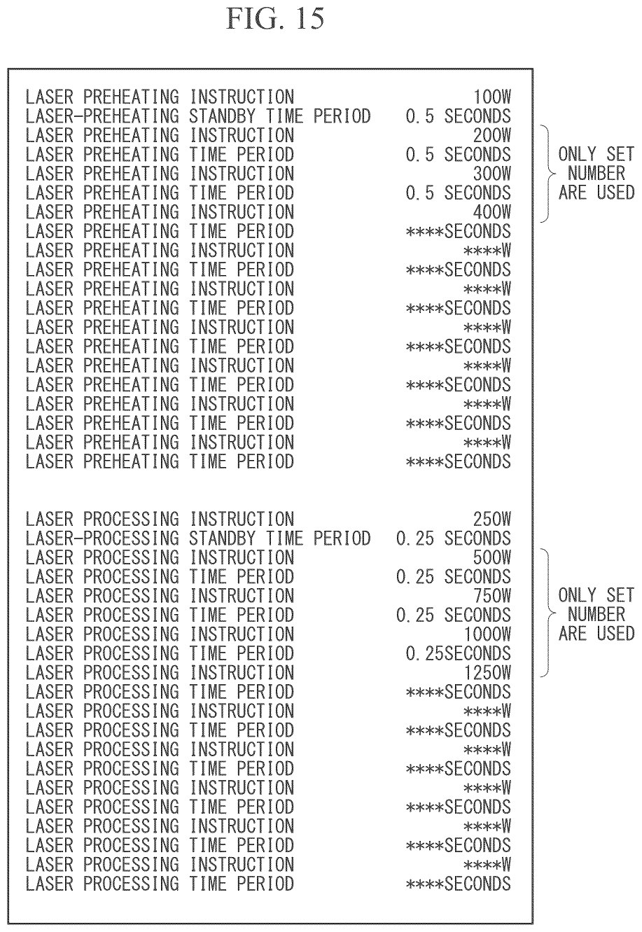

As shown in FIG. 14, a table having an input field where multiple laser emission instructions and emission time periods are settable without having to input the number of rampings may be stored, and only laser emission instructions equal in number to the number thereof input to the input field may be enabled. For example, in an example shown in FIG. 15, laser preheating instructions equivalent to three times of ramping and laser processing instructions equivalent to four times of ramping are set.

As an alternative to this embodiment where the preheating laser beam and the processing laser beam are described as the different types of laser beams, multiple laser beams of other different arbitrary types may be radiated.

For example, the embodiment may be applied to a case where the wavelengths are different, a case where the modes are different, as in a continuous laser beam and a pulsed laser beam, a case where the irradiation ranges are different, or a case where the spot shapes are different.

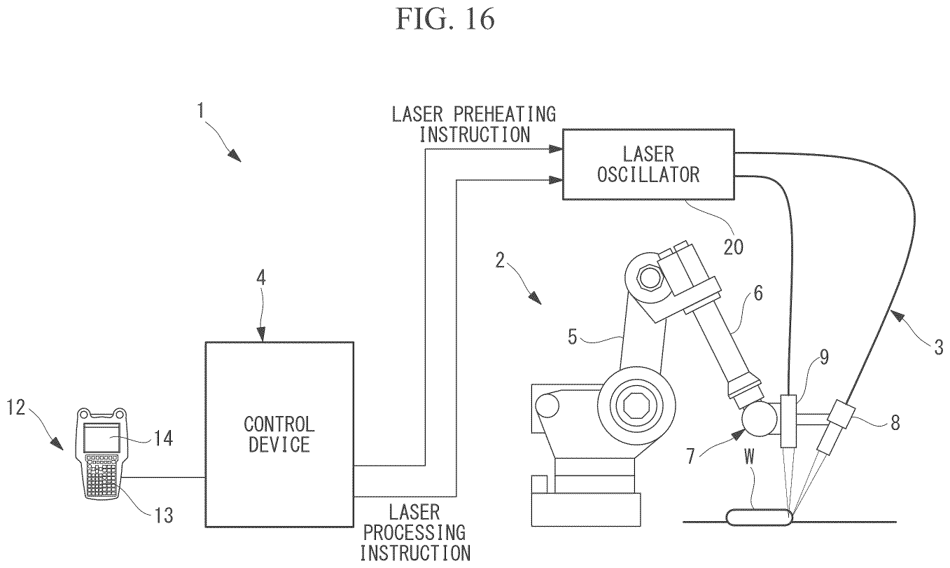

In this embodiment, the laser-light-emitting tool 3 includes the two types of tool bodies 8 and 9 and the two laser oscillators 10 and 11 respectively connected to the tool bodies 8 and 9. Alternatively, as shown in FIG. 16, the two types of tool bodies 8 and 9 may be connected to a common laser oscillator 20 equipped with an interface that receives a laser preheating instruction and an interface that receives a laser processing instruction.

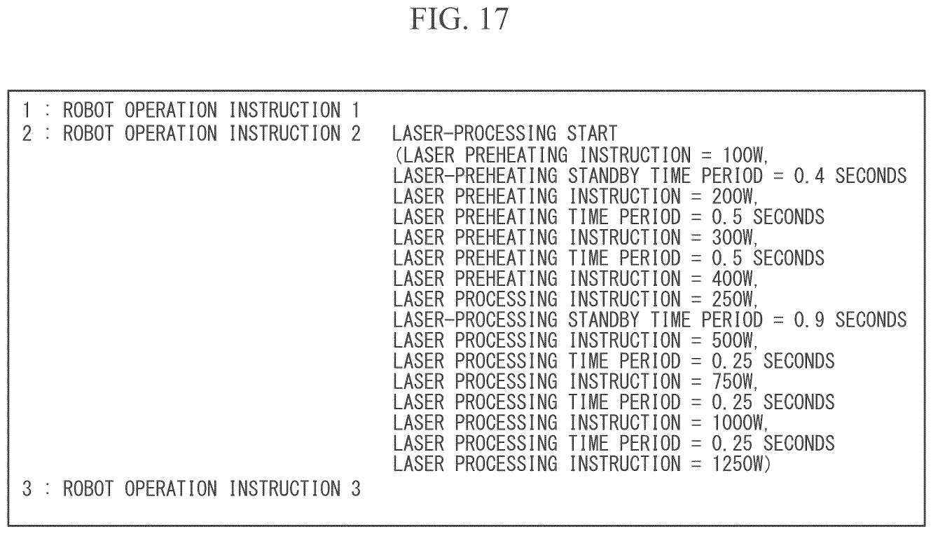

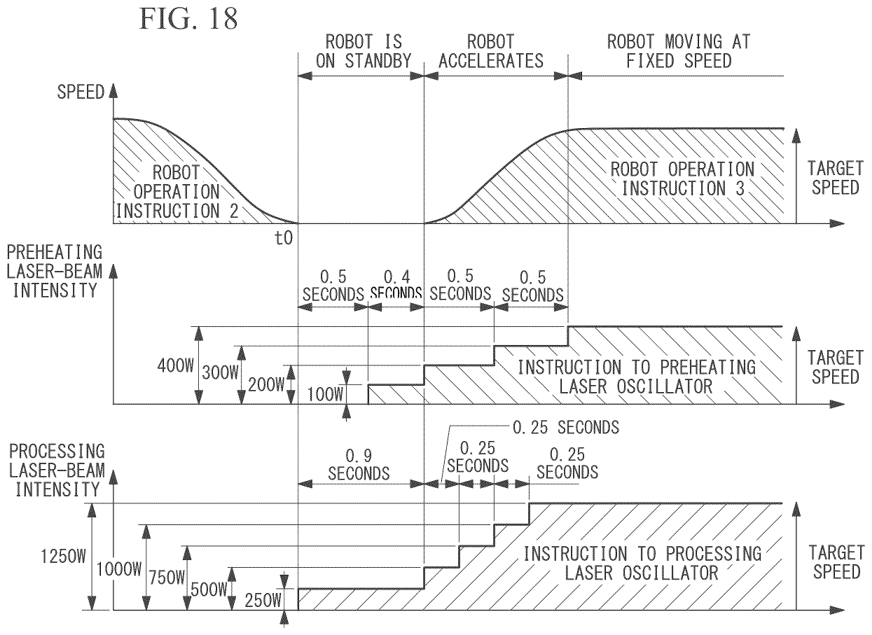

In this embodiment, the preheating laser beam is emitted for 0.5 seconds from the time point t0, and the processing laser beam is emitted for 0.25 seconds after 0.25 seconds from the time point t0. Alternatively, as shown in FIG. 17, the laser-preheating standby time period may be set to 0.4 seconds, and the laser-processing standby time period may be set to 0.9 seconds. Accordingly, as shown in FIG. 18, the processing laser beam can be emitted for 0.9 seconds from the time point t0, and the preheating laser beam can be emitted for 0.4 seconds after 0.5 seconds from the time point t0.

1. A laser processing system, comprising:
a robot, a laser-light-emitting tool attached to the robot, and a control device configured to control the robot and the laser-light-emitting tool based on an operation program,
wherein the laser-light-emitting tool is configured to emit two or more different types of laser beams independently of each other, and
wherein the control device is configured for executing a plurality of laser emission instructions for causing the laser-light-emitting tool to simultaneously emit the different types of laser beams in accordance with one laser processing command in the operation program.

2. The laser processing system according to claim 1, wherein the laser emission instructions include a preheating emission instruction and a processing emission instruction.

3. The laser processing system according to claim 1, wherein the control device is configured for setting an emission condition for each of the laser emission instructions in the laser processing command.

4. The laser processing system according to claim 3, wherein the emission condition includes intensities and emission time periods of the different types of laser beams to be emitted based on the laser emission instructions.

5. The laser processing system according to claim 1, wherein the laser emission instructions include a standby instruction for setting execution of an operation instruction for the robot on standby.

6. The laser processing system according to claim 3, wherein the control device lists and displays the plurality of laser emission instructions in an execution sequence in response to selection of the laser processing command in a teaching process of the operation program, and allows the emission condition to be input for each laser emission instruction.

7. The laser processing system according to claim 6,
wherein the laser processing command is a laser-processing start command, and
wherein, when the laser processing command is selected in the teaching process of the operation program, the control device makes a request for an input of the number of rampings for each laser emission instruction, and lists and displays the laser emission instructions the number of which corresponds to the number of rampings input in response to the request.

8. The laser processing system according to claim 6,
wherein the laser processing command is a laser-processing end instruction, and
wherein, when the laser processing command is selected in the teaching process of the operation program, the control device makes a request for an input of the number of rampings for each laser emission instruction, and lists and displays the laser emission instructions the number of which corresponds to the number of rampings input in response to the request.

9. The laser processing system according to claim 6,
wherein the laser processing command is a laser-emission-condition changing instruction during laser processing, and
wherein, when the laser processing command is selected in the teaching process of the operation program, the control device makes a request for an input of the number of rampings for each laser emission instruction, and lists and displays the laser emission instructions the number of which corresponds to the number of rampings input in response to the request.

10. The laser processing system according to claim 6,
wherein one or more tables are stored, each table having the plurality of laser emission instructions listed in the execution sequence, the plurality of laser emission instructions being for emitting the different types of laser beams, and
wherein the selection of the laser processing command involves selecting any one of the tables and displaying the selected table.

11. The laser processing system according to claim 10,
wherein the laser processing command is a laser-processing start command, and
wherein, when the laser processing command is selected in the teaching process of the operation program, the control device displays the selected table, makes a request for an input of the number of rampings for each laser emission instruction in the displayed table, and lists and displays the laser emission instructions in the table, the number of the laser emission instructions corresponding to the number of rampings input in response to the request.

12. The laser processing system according to claim 10,
wherein the laser processing command is a laser-processing end instruction, and
wherein, when the laser processing command is selected in the teaching process of the operation program, the control device displays the selected table, makes a request for an input of the number of rampings for each laser emission instruction in the displayed table, and lists and displays the laser emission instructions in the table, the number of the laser emission instructions corresponding to the number of rampings input in response to the request.

13. The laser processing system according to claim 10,
wherein the laser processing command is a laser-emission-condition changing instruction during laser processing, and
wherein, when the laser processing command is selected in the teaching process of the operation program, the control device displays the selected table, makes a request for an input of the number of rampings for each laser emission instruction in the displayed table, and lists and displays the laser emission instructions in the table, the number of the laser emission instructions corresponding to the number of rampings input in response to the request.

14. A control device that controls a robot and a laser-light-emitting tool attached to the robot based on an operation program,
wherein the control device is configured to execute a plurality of laser emission instructions for causing the laser-light-emitting tool to simultaneously emit two or more different types of laser beams in accordance with one laser processing command in the operation program.

15. The control device according to claim 14, wherein the laser emission instructions include a preheating emission instruction and a processing emission instruction.

16. The control device according to claim 14, wherein an emission condition for each of the laser emission instructions in the laser processing command is settable.

17. The control device according to claim 16, wherein the emission condition includes intensities and emission time periods of the different types of laser beams to be emitted based on the laser emission instructions.

18. The control device according to claim 14, wherein the laser emission instructions include a standby instruction for setting execution of an operation instruction for the robot on standby.

19. The control device according to claim 16, wherein the plurality of laser emission instructions are listed and displayed in an execution sequence in response to selection of the laser processing command in a teaching process of the operation program, and the emission condition is input for each laser emission instruction.

20. The control device according to claim 19, wherein the laser processing command is a laser-processing start command, and
wherein, when the laser processing command is selected in the teaching process of the operation program, a request is made for an input of the number of rampings for each laser emission instruction, and the laser emission instructions the number of which corresponds to the number of rampings input in response to the request are listed and displayed.

21. The control device according to claim 19,
wherein the laser processing command is a laser-processing end instruction, and
wherein, when the laser processing command is selected in the teaching process of the operation program, a request is made for an input of the number of rampings for each laser emission instruction, and the laser emission instructions the number of which corresponds to the number of rampings input in response to the request are listed and displayed.

22. The control device according to claim 19,
wherein the laser processing command is a laser-emission-condition changing instruction during laser processing, and
wherein, when the laser processing command is selected in the teaching process of the operation program, a request is made for an input of the number of rampings for each laser emission instruction, and the laser emission instructions the number of which corresponds to the number of rampings input in response to the request are listed and displayed.

23. The control device according to claim 19,
wherein one or more tables are stored, each table having the plurality of laser emission instructions listed in the execution sequence, the plurality of laser emission instructions being for emitting the different types of laser beams, and
wherein the selection of the laser processing command involves selecting any one of the tables and displaying the selected table.

24. The control device according to claim 23,
wherein the laser processing command is a laser-processing start command, and
wherein, when the laser processing command is selected in the teaching process of the operation program, the selected table is displayed, a request is made for an input of the number of rampings for each laser emission instruction in the displayed table, and the laser emission instructions are listed and displayed in the table, the number of the laser emission instructions corresponding to the number of rampings input in response to the request.

25. The control device according to claim 23,
wherein the laser processing command is a laser-processing end instruction, and
wherein, when the laser processing command is selected in the teaching process of the operation program, the selected table is displayed, a request is made for an input of the number of rampings for each laser emission instruction in the displayed table, and the laser emission instructions are listed and displayed in the table, the number of the laser emission instructions corresponding to the number of rampings input in response to the request.

26. The control device according to claim 23,
wherein the laser processing command is a laser-emission-condition changing instruction during laser processing, and
wherein, when the laser processing command is selected in the teaching process of the operation program, the selected table is displayed, a request is made for an input of the number of rampings for each laser emission instruction in the displayed table, and the laser emission instructions are listed and displayed in the table, the number of the laser emission instructions corresponding to the number of rampings input in response to the request.
